(19) United States
(12) Patent Application Publication
(10) Pub. No.: US 2008/0264556 A1
(43) Pub. Date: Oct. 30, 2008

(54) LABEL

(75) Inventor: Paul Anthony Miller, Kambath (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Global Apeel Limited

(21) Appl. No.: 12/122,948

(22) Filed: May 19, 2008

Related U.S. Application Data
(63) Continuation of application No. 11/213,611, filed on Aug. 26, 2005, now abandoned.
Application No. 11/213,611 is a continuation-in-part of application No. 10/794,963, filed on Mar. 5, 2004.
Application No. 10/794,963 is a continuation-in-part of application No. PCT/AU02/01224, filed on Sep. 5, 2002.
Application No. PCT/AU02/01224 is a continuation of application No. PCT/AU2004/000259, filed on Feb. 27, 2004.

(30) Foreign Application Priority Data
Sep. 5, 2001 (AU) PR7493
Feb. 27, 2003 (AU) 2003900886
Jan. 25, 2005 (AU) PS0122

(51) Int. Cl. B32B 38/10; B32B 33/00

(52) U.S. Cl. 156/249; 428/42.2

(57) ABSTRACT

A label for affixing to a container is disclosed, the label including a front portion for carrying labelling indicia, and an adhesive backing; the front portion including a token, the token being readily severable from the front portion when the label is affixed to the container.

### CROSS-REFERENCE TO RELATED APPLICATIONS

This application is a continuation of U.S. application Ser. No. 11/213,611, filed Aug. 26, 2005, which is a continuation-in-part of U.S. application Ser. No. 10/794,963, filed Mar. 5, 2004, which is a continuation-in-part of PCT Application No. PCT/AU02/01224, filed Sep. 5, 2002, which claims priority from Australian Patent Application Nos. PR 7493 filed Sep. 5, 2001 and PS 0122 filed Jan. 25, 2002, and is a continuation of PCT/AU2004/000259, filed Feb. 27, 2004, which claims priority from Australian provisional Application No. 2003900886, filed Feb. 27, 2003, which are hereby incorporated herein by reference.

### TECHNICAL FIELD

This invention relates to a label.

The invention has particular application to labels and labelling methods which include a frangible or severable portion.

The invention is particularly suited for use in the wine industry.

### BACKGROUND OF INVENTION

It is known for adhesive labels to be attached to wine bottles and the like.

### SUMMARY OF INVENTION

The present invention aims to provide an alternative to known labels and labelling methods.

This invention in one aspect resides broadly in a label for affixing to a container, the label including:

a front portion for carrying labelling indicia;

an adhesive backing substantially covering one side of the front portion;

a non-stick backing sheet affixed to the adhesive backing; and

a token;

a portion of the front portion constituting the token and being readily severable from the front portion when the label is affixed to the container, a portion of the backing sheet being removable from the adhesive backing such that another portion of the backing sheet remains attached to the token, the said other portion of the backing sheet remaining attached to the token when the token is severed from the front portion when affixed to the container to thereby prevent the token fully adhering to another surface without first removing the said other portion of the backing sheet from the token.

It is also preferred that the front portion has perforations to facilitate the severing of the token therefrom.

It is also preferred that the perforations in the front portion extend into the backing sheet affixed to the adhesive backing.

It is also preferred that the backing sheet is cut through proximate the perforations such that a portion of the backing sheet remains attached to the token when the remainder of the backing sheet is removed from the adhesive backing for affixing the label to a container.

In another aspect this invention resides broadly in a method of labelling a container, the method including:

providing a label for affixing to the container, the label having a front portion for carrying labelling indicia, an adhesive backing substantially covering one side of the front portion, a non-stick backing sheet affixed to the adhesive backing, and a token; a portion of the front portion constituting the token;

removing a portion of the backing sheet from the adhesive backing such that another portion of the backing sheet remains attached to the token, the said other portion of the backing sheet remaining attached to the token when the token is severed from the front portion when affixed to the container to thereby prevent the token fully adhering to another surface without first removing the said other portion of the backing sheet from the token; and

affixing the label to the container by the adhesive exposed when the portion of the backing sheet is removed therefrom;

the token being readily severable from the front portion when the label is affixed to the container.

In another aspect this invention resides broadly in a roll of labels for affixing to a container, each label including:

a front portion for carrying labelling indicia;

an adhesive backing substantially covering one side of the front portion;

a non-stick backing sheet affixed to the adhesive backing; and

a token;

a portion of the front portion constituting the token and being readily severable from the front portion when the label is affixed to the container, a portion of the backing sheet being removable from the adhesive backing such that another portion of the backing sheet remains attached to the token, the said other portion of the backing sheet remaining attached to the token when the token is severed from the front portion when affixed to the container to thereby prevent the token fully adhering to another surface without first removing the said other portion of the backing sheet from the token;

wherein the non stick backing sheet constitutes continuous material forming the roll.

In another aspect this invention resides broadly in a label for affixing to a container, the label including:

a front portion for carrying labelling indicia;

an adhesive backing substantially covering one side of the front portion;

a non-stick backing sheet affixed to the adhesive backing, and

a token;

a portion of the front portion constituting the token and being readily severable from the front portion when the label is affixed to the container, a portion of the backing sheet being removable from the adhesive backing such that another portion of the backing sheet remains attached to the token;

wherein the non-stick backing sheet constitutes continuous material forming the roll.

In another aspect this invention resides broadly in a label for affixing to a container, the label including:

a front portion for carrying labelling indicia;

an adhesive backing substantially covering one side of the front portion; a non-stick backing sheet affixed to the adhesive backing; and

a token;

a portion of the front portion constituting the token and being readily severable from the front portion when the label is affixed to the container, a portion of the backing sheet being removable from the adhesive backing such that another portion of the backing sheet remains attached to the token;

wherein the backing sheet is cut through such that the other portion of the backing sheet which remains attached to the token is smaller than the token, the adhesive where the larger token extends beyond the smaller other portion of the backing sheet being less adhesive than the adhesive backing.

It is preferred that the token forms an edge portion extending around the other portion of the backing sheet remaining attached to the token.

It is also preferred that the adhesive on the edge portion is stamped to render it less adhesive.

In another aspect this invention resides broadly in a method of labelling a container with a label as defined above.

In another aspect this invention resides broadly in a roll of labels as defined above for affixing to a container.

### DESCRIPTION OF DRAWINGS

In order that this invention may be more easily understood and put into practical effect, reference will now be made to the accompanying drawings which illustrate a preferred embodiment of the invention, wherein:

FIG. 1 is a perspective view of a label in accordance with the invention on a wine bottle, and

FIG. 2 is a perspective view of the label of FIG. 1 showing the token partially removed;

FIGS. 3-7 illustrate a first embodiment of the invention, wherein:

FIG. 3 is a cross-sectional elevation through the label of FIG. 1 as seen along AA;

FIG. 4 is a perspective view of the rear of the label with the non-stick backing affixed;

FIG. 5 is a perspective view of the rear of the label with the non-stick backing removed;

FIG. 6 is a perspective view of the front of the label with the token intact, and

FIG. 7 is a perspective view of the front of the label with the token removed;

FIGS. 8-12 illustrate a second embodiment of the invention in views which correspond with those of FIGS. 3-7 as described above with respect to the first embodiment of the invention.

### DESCRIPTION OF PREFERRED EMBODIMENTS OF INVENTION

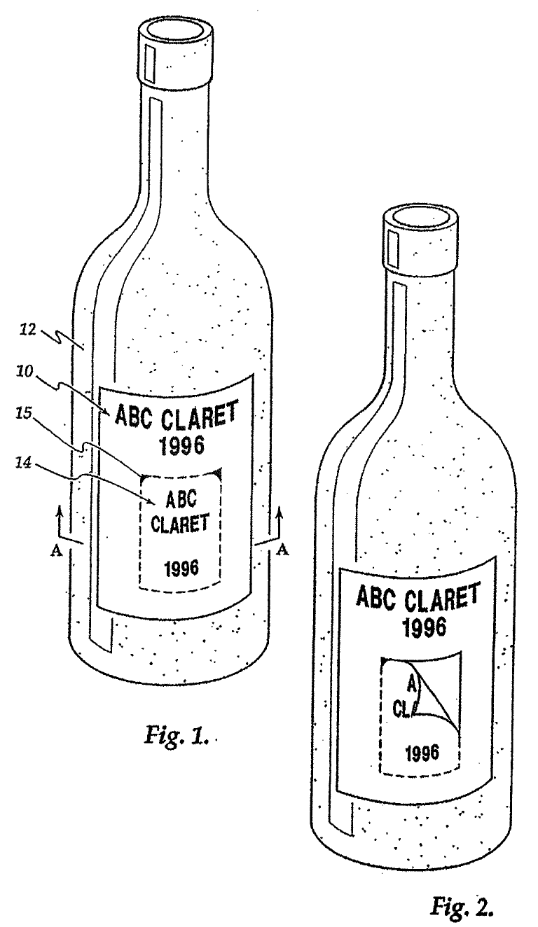

As can be seen in FIG. 1, a wine label 10 is affixed to a bottle 12 and has a tear-out token 14 which can be readily removed for collection or future reference by peeling back a tab 15, as best seen in FIG. 2.

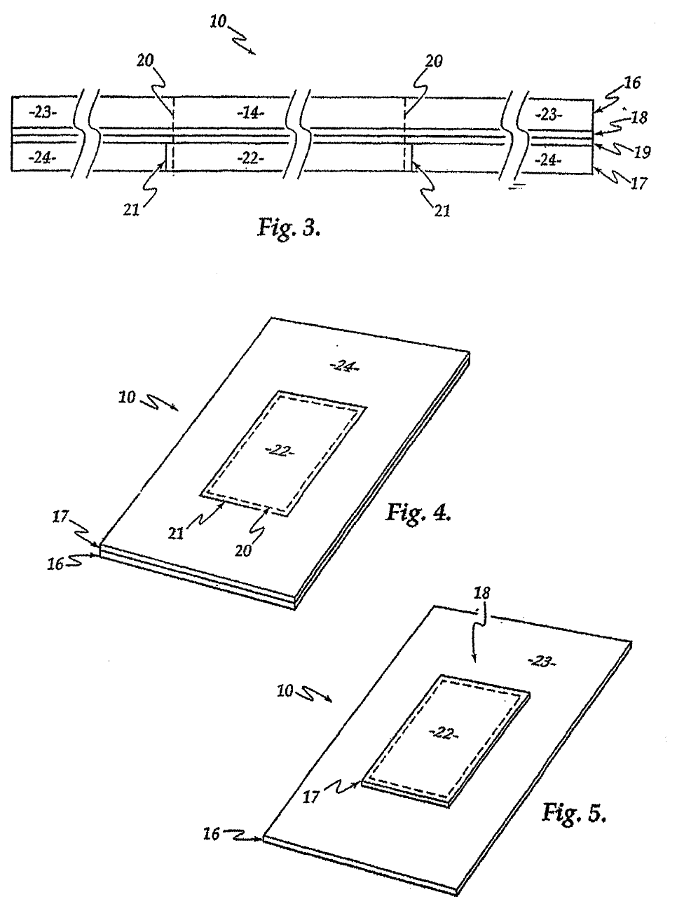

FIG. 3 is a cross-sectional elevation through the label along line AA seen in FIG 1. Illustrating a first embodiment of the invention, it shows the composition of label 10 as including a front portion 16 for carrying labelling indicia and an adhesive backing 18. Front portion 16 has a token 14 for identifying the wine and as seen in FIG. 2, is readily severable from the front portion 16 when the label 10 is affixed to the bottle.

Label 10 also includes a non-stick backing sheet 17,19 affixed to adhesive backing 18. The backing sheet has a paper or paper-like substrate 17 and a non-stick layer 19 in known manner. Perforations 20 in front portion 16 facilitate the severing of token 14 from the front portion, and extend into the backing sheet 17 affixed to adhesive backing 18 by non-stick layer 19.

Backing sheet 17 is also is cut through at 21 proximate perforations 20, shown in FIGS. 4 and 5 externally of the perforations, such that a portion 22 of backing sheet 17 remains attached to token 14 when the remainder 24 of backing sheet 17 is removed from adhesive backing 18 for affixing label 10 to bottle 12. Cut 21 can also be made within the perforation 20, and in this preferred embodiment a thin strip of adhesive remains affixed to the underside of the edge of token 14.

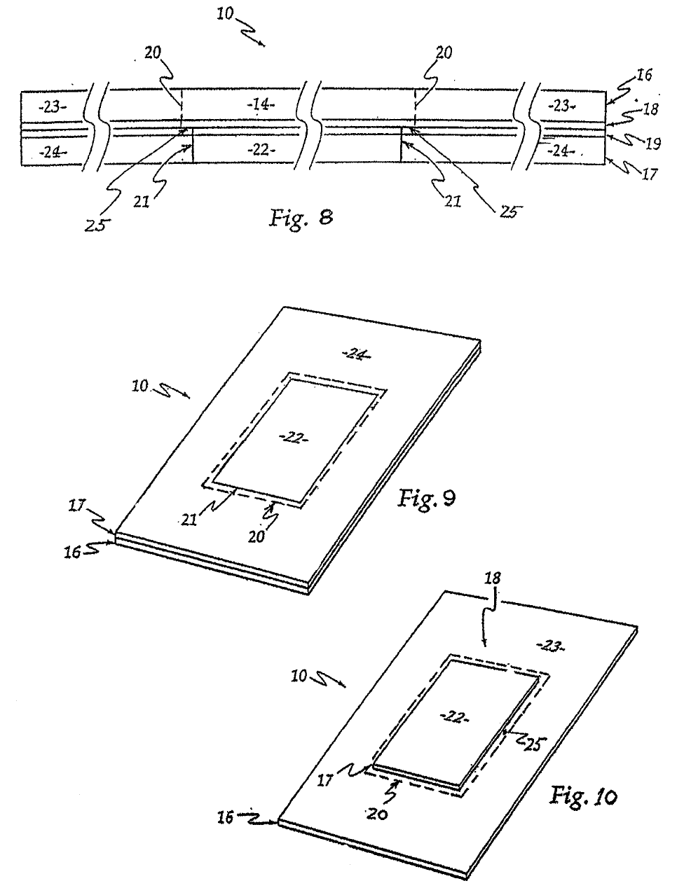

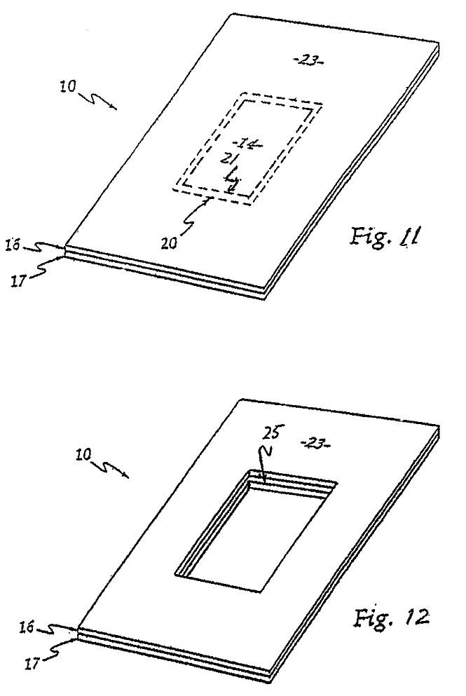

FIGS. 8 - 12 illustrate a second embodiment of the invention in views which correspond with those of FIGS. 3-7 as described above with respect to the first embodiment of the invention. For convenience of reference and description, where the features correspond, the reference numerals used in the embodiment illustrated in FIGS. 8-12 are the same as those used in the above description of the first embodiment.

FIG. 8 is a cross-sectional elevation of the second embodiment of the invention through the label along line AA seen in FIG. 1 and illustrates the composition of label 10 as including a front portion 16 for carrying labelling indicia and an adhesive backing 18. Front portion 16 has a token 14 for identifying the wine and as seen in FIG. 2, is readily severable from the front portion 16 when the label 10 is affixed to the bottle.

Label 10 also includes a non-stick backing sheet 17,19 affixed to adhesive backing 18. The backing sheet has a paper or paper-like substrate 17 and a non-stick layer 19 in known manner. Perforations 20 in front portion 16 facilitate the severing of token 14 from the front portion and extend into the backing sheet 17 affixed to adhesive backing 18 by non-stick layer 19.

Backing sheet 17 is cut through at 21 internally of perforations 20, such that a portion 22 of backing sheet 17 remains attached to token 14 when the remainder 24 of backing sheet 17 is removed from adhesive backing 18 for affixing label 10 to bottle 12. Cut 21 is within the perforation 20 so that a thin strip 25 of adhesive remains affixed to the underside of the edge of token 14.

The adhesive on strip 25 is of lesser adhesiveness than the remainder of adhesive backing 18. In practice the adhesive on strip 25 can be deadened by stamping this strip with a suitably shaped stamp or die, whereby the adhesiveness of this portion 25 of adhesive backing 18 is reduced. Alternatively in another preferred embodiment the adhesive on strip 25 is rendered less adhesive by application thereto of a deadening agent. Typically the deadening agent can be an ink varnish or other solvent designed to reduce the adhesion of this edge portion.

It will be appreciated that the edge portion 25 of reduced adhesiveness is attached to the container less aggressively than the remainder of label 10, thereby facilitating the removal of token 14 together with the backing sheet portion 22.

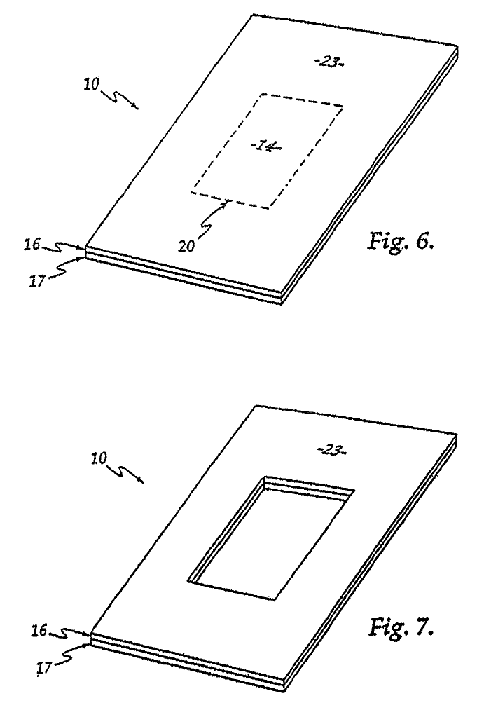

In use, as best seen in FIGS. 4-7 and 9-12, a wine or other produce in a container is labelled in according with the present invention with a label 10 having a front portion 16 for carrying labelling indicia and having a token 14 for identifying the wine, an adhesive backing 18, and a non-stick backing sheet 17 affixed to adhesive backing 18. As seen in FIGS. 5 and 10, portion 24 of backing sheet 17 is removed from adhesive backing 18 such that another portion 22 of backing sheet 17 remains attached to token 14. Label 10 is affixed to the bottle by the adhesive backing 18 exposed when portion 24 of backing sheet 17 is removed. As seen in FIGS. 6, 7, 11 and 12, token 14 is readily severable from front portion 16 when label 10 is affixed to the bottle, leaving portion 23 of label 10 remaining affixed to the bottle.

It will be readily appreciated that non-stick backing sheet 17,19 affixed to adhesive backing 18 can be a portion of a continuous length of non-stick backing sheet material and which in known manner can be wound into a roll.

It will be appreciated that the present invention has many uses and advantages over known labels. For example with wine labelled in accordance with the invention, at restaurants or the like when the wine has been enjoyed the token can be removed and retained as an aide-memoir, souvenir, collectible etc, thereby removing the necessity to write the name or details of the wine on a piece of paper. Token 14 can be readily fixed in a scrap-book or the like by peeling back non-stick portion 22 to expose the adhesive layer 18 on the token.

It also avoids the practice of soaking off wine labels, which is difficult with more modern labels which use contact adhesives often sufficiently aggressive to result in the label being destroyed in attempts to remove it.

The invention is also useful in conducting promotions of goods bearing the label. For example, prizes can be offered for the return of a given number of tokens which have been removed from the labels.

It will of course be realized that whilst the above has been given by way of an illustrative example of this invention, all such and other modifications and variations hereto, as would be apparent to persons skilled in the art, are deemed to fall within the broad scope and ambit of this invention as is herein set forth.

1. A label for affixing to a container, the label including:
a front portion for carrying labelling indicia;
an adhesive backing substantially covering one side of the front portion;
a non-stick backing sheet affixed to the adhesive backing; and
a token;
a portion of the front portion constituting the token and being readily severable from the front portion when the label is affixed to the container, a portion of the backing sheet being removable from the adhesive backing such that another portion of the backing sheet remains attached to the token, the said other portion of the backing sheet remaining attached to the token when the token is severed from the front portion when affixed to the container to thereby prevent the token fully adhering to another surface without first removing the said other portion of the backing sheet from the token.

2. A label as claimed in claim 1, wherein the front portion has perforations to facilitate the severing of the token therefrom.

3. A label as claimed in claim 2, wherein the perforations in the front portion extend into the backing sheet affixed to the adhesive backing.

4. A label as claimed in claim 2, wherein the backing sheet is cut through proximate the perforations such that a portion of the backing sheet remains attached to the token when the remainder of the backing sheet is removed from the adhesive backing for affixing the label to a container.

5. A label as claimed in claim 4, wherein the backing sheet is cut through internally of the perforations.

6. A method of labelling a container, the method including:
providing a label for affixing to the container, the label having a front portion for carrying labelling indicia, an adhesive backing substantially covering one side of the front portion, a non-stick backing sheet affixed to the adhesive backing; and
a token;
a portion of the front portion constituting the token;
removing a portion of the backing sheet from the adhesive backing such that another portion of the backing sheet remains attached to the token, the said other portion of the backing sheet remaining attached to the token when the token is severed from the front portion when affixed to the container to thereby prevent the token fully adhering to another surface without first removing the said other portion of the backing sheet from the token; and
affixing the label to the container by the adhesive exposed when the portion of the backing sheet is removed therefrom;
the token being readily severable from the front portion when the label is affixed to the container.

7. A roll of labels for affixing to a container, each label including:
a front portion for carrying labelling indicia;
an adhesive backing substantially covering one side of the front portion;
a non-stick backing sheet affixed to the adhesive backing; and
a token;
a portion of the front portion constituting the token and being readily severable from the front portion when the label is affixed to the container, a portion of the backing sheet being removable from the adhesive backing such that another portion of the backing sheet remains attached to the token the said other portion of the backing sheet remaining attached to the token when the token is severed from the front portion when affixed to the container to thereby prevent the token fully adhering to another surface without first removing the said other portion of the backing sheet from the token;
wherein the non stick backing sheet constitutes continuous material forming the roll.

8. A label for affixing to a container, the label including:
a front portion for carrying labelling indicia;
an adhesive backing substantially covering one side of the front portion;
a non-stick backing sheet affixed to the adhesive backing; and
a token;
a portion of the front portion constituting the token and being readily severable from the front portion when the label is affixed to the container, a portion of the backing sheet being removable from the adhesive backing such that another portion of the backing sheet remains attached to the token;
wherein perforations in the front portion defining the token do not extend into the backing sheet, and
wherein the backing sheet is cut through such that the other portion of the backing sheet which remains attached to the token is smaller than the token, the adhesive where the larger token extending beyond the smaller other portion of the backing sheet being less adhesive than the adhesive backing.

9. A label as claimed in claim 8, wherein the token forms an edge portion extending around the other portion of the backing sheet remaining attached to the token.

10. A label as claimed in claim 9, wherein the adhesive on the edge portion is less adhesive than the adhesive backing.

11. A label as claimed in claim 10 wherein a deadening agent is applied to the adhesive on the edge portion to render it less adhesive.

12. A label as claimed in claim 9, wherein the adhesive on the edge portion is stamped to render it less adhesive.
